(19) United States
(12) Patent Application Publication
(10) Pub. No.: US 2015/0081243 A1
(43) Pub. Date: Mar. 19, 2015

(54) Setsudo: Pertubation-based Testing Framework for Scalable Distributed Systems

(71) Applicant: NEC Laboratories America, Inc., Princeton, NJ (US)

(72) Inventors: Malay Ganai, Plainsboro, NJ (US); Gogul Balakrishnan, Princeton, NJ (US); Pallavi Joshi, Plainsboro, NJ (US); Aarti Gupta, Princeton, NJ (US)

(73) Assignee: NEC Laboratories America, Inc., Princeton, NJ (US)

(21) Appl. No.: 14/217,566

(22) Filed: Mar. 18, 2014

Related U.S. Application Data
(60) Provisional application No. 61/803,693, filed on Mar. 20, 2013.

(51) Int. Cl. G06F 11/263; G06F 11/36

(52) U.S. Cl. CPC G06F 11/263; G06F 11/3688
USPC 702/123

(57) ABSTRACT

Disclosed are a testing framework—SETSUD Ō—that uses perturbation-based exploration for robustness testing of modern scalable distributed systems. In sharp contrast to existing testing techniques and tools that are limited in that they are typically based on black-box approaches or they focus mostly on failure recovery testing, SETSUD Ō is a flexible framework to exercise various perturbations to create stressful scenarios. SETSUD Ō is built on an underlying instrumentation infrastructure that provides abstractions of internal states of the system as labeled entities. Both novice and advanced testers can use these labeled entities to specify scenarios of interest at the high level, in the form of a declarative style test policy. SETSUD Ō automatically generates perturbation sequences and applies them to system-level implementations, without burdening the tester with low-level details.

### CROSS REFERENCE TO RELATED APPLICATION

This application claims the benefit of U.S. Provisional Application Ser. No. 61/803,693 filed Mar. 20, 2013.

### TECHNICAL FIELD

This disclosure relates generally to the field of computer software systems and in particular to methods and structures for exposing system-level defects in scalable distributed systems.

### BACKGROUND

Contemporary society is placing an ever-increasing reliance on scalable distributed systems which support web server applications that experience enormous peak load requests. Such systems permit the deployment of these applications on relatively inexpensive commodity hardware while allowing them to scale horizontally (i.e., elastically) with the addition of additional hardware (nodes) as required. Given their importance, techniques that facilitate the testing of such systems would represent a welcome addition to the art.

### SUMMARY

An advance is made in the art according to aspects of the present disclosure directed to a perturbation-based rigorous testing framework we call SETSUD Ō which exposes system-level defects in scalable distributed systems. Operationally, SETSUD Ō applies perturbations (controlled changes) from the environment of a system during its testing, and leverages of awareness of system-internal states to precisely control their timing. SETSUD Ō employs a flexible instrumentation framework to select relevant internal states and to implement the system code for perturbations.

Viewed from a first aspect our disclosure pertains to a computer implemented method of performing perturbation-based testing of scalable distributed systems under test (SUT) which 1) induces controlled changes to an execution of a SUT using custom triggers that correspond to environment triggers on which the SUT does not have any control; and monitors the SUT for any deviation in an expected behavior of the SUT; and then reports any deviations in expected behavior of the SUT.

### BRIEF DESCRIPTION OF THE DRAWING

A more complete understanding of the present disclosure may be realized by reference to the accompanying drawings in which:

FIG. 1 is a schematic diagram depicting a scalable distributed system according to an aspect of the present disclosure;

FIG. 2 is a schematic diagram depicting an exemplary partition recovery according to an aspect of the present disclosure;

FIG. 3 is a schematic diagram depicting an exemplary SETSUD Ō testing framework according to an aspect of the present disclosure;

FIG. 4 is an exemplary perturbation sequence that exposes SOLR-3939 according to an aspect of the present disclosure;

FIG. 5 depicts aspects for determining ZooKeeper leaders according to the present disclosure;

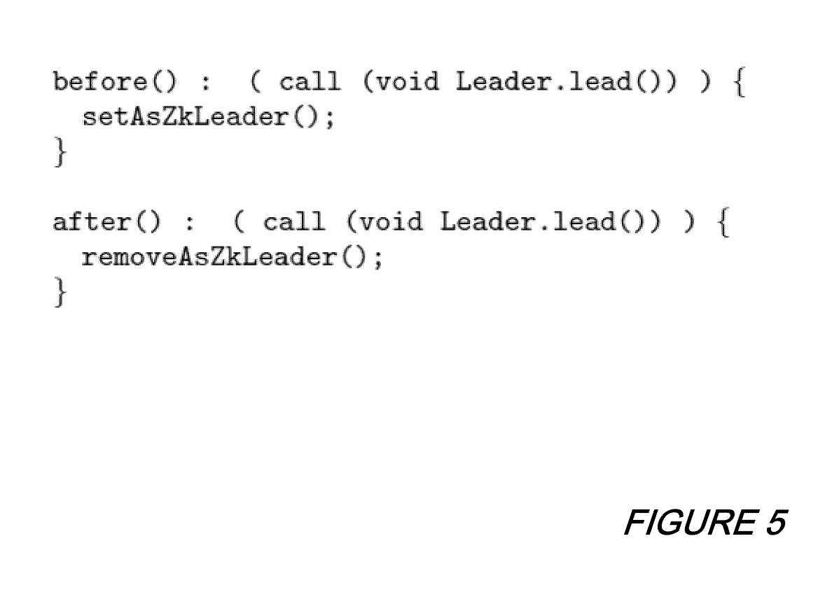

FIG. 6 is a graph showing the number of distinct perturbation scenarios covered with and without state information in Solr according to aspects of the present disclosure;

FIG. 7 shows Algorithm 1 Perturbation Sequence Exerciser according to an aspect of the present disclosure;

FIG. 8 shows a Table 1 of Labeled Entities for SolrCloud application according to an aspect of the present disclosure;

FIG. 9 shows a Table 2 of Evaluation results for SETSUD Ō on SolrCloud (Solr), Zookeeper (Zk), Cassandra (Cass) and Hbase according to aspects of the present disclosure; and

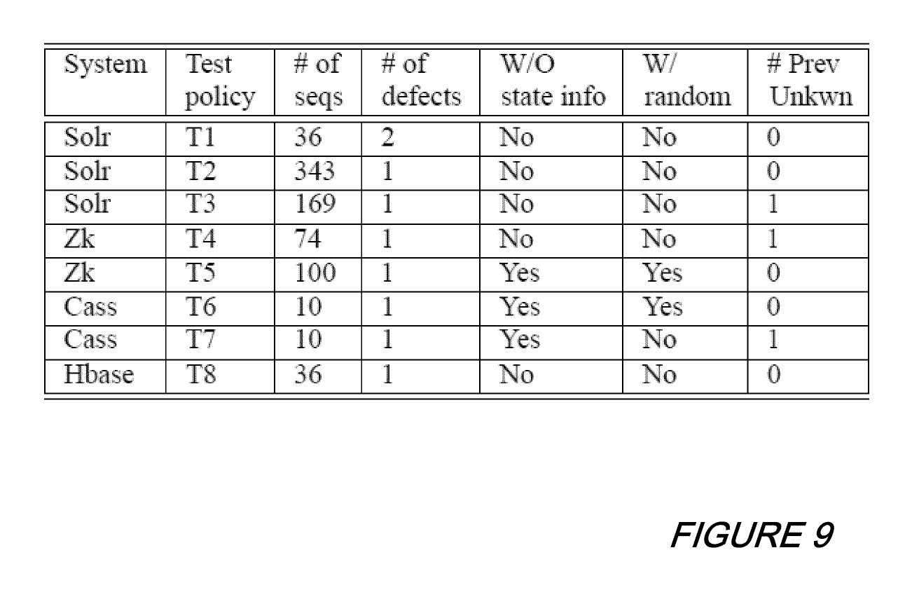

FIG. 10 shows a schematic block diagram of an exemplary computer system on which methods of the present disclosure may be executed.

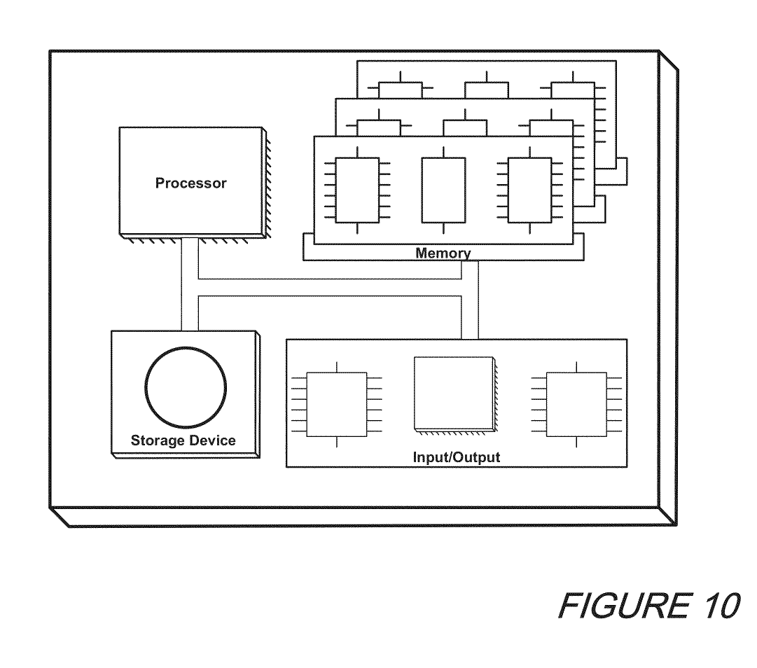

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

### Introduction

By way of some additional background, we note that modern scalable distributed systems are designed to be partition-tolerant. They are often required to support increasing load in service requests elastically, and to provide seamless services even when some servers malfunction. Partition-tolerance enables such systems to withstand arbitrary loss of messages as “perceived” by the communicating nodes. However, partition-tolerance and robustness are not tested rigorously in practice. Often severe system-level design defects stay hidden even after deployment, possibly resulting in loss of revenue or customer satisfaction.

Accordingly we now disclose a perturbation-based rigorous testing framework, named SETSUD Ō, particularly useful to expose system-level defects in scalable distributed systems. It applies perturbations (i.e., controlled changes) from the environment of a system during testing, and leverages awareness of system-internal states to precisely control their timing. It uses a flexible instrumentation framework to select relevant internal states and to implement the system code for perturbations. It also provides a test policy language framework, where sequences of perturbation scenarios at a high level are converted automatically to system-level test code. This test code is weaved-in automatically with application code during testing, and any observed defects are reported.

We have implemented our perturbation testing framework and demonstrate its evaluation on several open source projects, where it was successful in exposing known, as well as some unknown, defects. Our framework leverages small-scale testing, and avoids upfront infrastructure costs typically needed for large-scale stress testing.

### Introduction

Modern scalable distributed systems (SDS) are designed to support increasing peak load requests and data traffic. These systems have made it possible to deploy web server applications on cheap commodity hardware, and allow them to scale horizontally (i.e., elastically) with addition of more nodes as needed. Many of these systems are specially designed to support multi-homing web services, i.e., serving from multiple data centers in potentially geo-separated locations, with additional requirements of partition-tolerance, availability, and consistency. Notably, a requirement of low latency (even without a partition) can be deemed as low tolerance to communication delay, and hence such services are inherently partition-tolerant. For example, in a data center, where physical partitions may be rare, a slow network link is perceived as a partition.

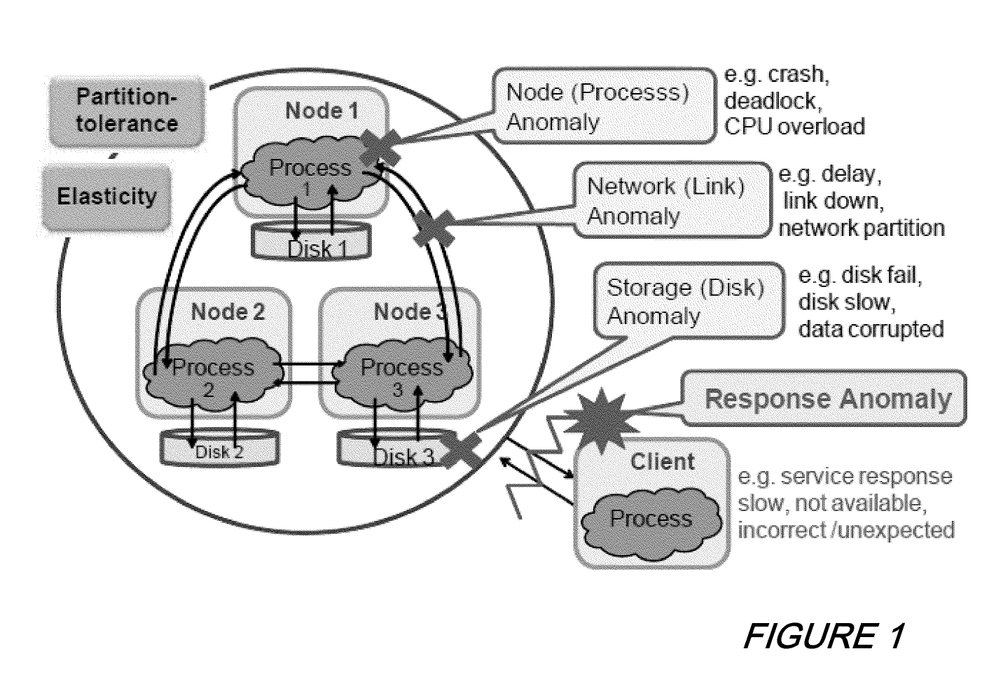

A partition-tolerant system should continue to operate and provide seamless services—possibly with reduced functionality (maybe with a tradeoff on availability or consistency)—when nodes detect an actual or perceived loss of communicating messages (a partition). A partition can be caused by various anomalies, such as in the network (link failures, link congestions, packet drops), node (process crash, uncaught exception, deadlocks, CPU overload), or disk (slow response, failures, corruption), as illustrated in FIG. 1. Since network partitions (including delays that seem like partitions) are quite common, most scalable distributed systems aim to achieve partition-tolerance.

A partition-tolerant system that emphasizes consistency over availability (i.e., a CP system) should provide consistent results during partitions using built-in redundancy. However, if it fails to do so, it may alternatively return an unavailable exception (for example, “try again later”). Such built-in redundancy is achieved through complex software systems and structures which are in general hard to test. Similarly, a partition-tolerant system that provides availability over consistency (i.e., an AP system) should provide consistent results during partition using built-in redundancy, but when it fails to do so, it may supply stale data (which eventually may be corrected). Such partition-tolerant systems favoring consistency or availability must of course take into consideration any anomalies that may occur at any time, even when the system is still recovering.

Due to implementation oversights however, such as fine-grained timing bugs (i.e., due to ordering), memory-related bugs, functional bugs, configuration bugs, etc., a desired “tolerance” may not be achieved in practice. This may result in a slow response, no response, or an incorrect response to a client request, which we refer to generally as a response anomaly.

One goal therefore of the present disclosure is to expose such implementation oversights, which we refer to as “robustness defects.” To expose these defects, we apply (i.e., simulate) stress-like perturbations (i.e., controlled changes) from an environment of a running distributed system and check for any response anomaly. And while we use specific exemplary partition-tolerant systems in this disclosure, those skilled in the art will readily appreciate that our approach is applicable to any distributed system.

### Overview of Perturbation Testing

We discose herein a perturbation-based rigorous testing framework we call SETSUD Ō that is specifically useful to expose system-level defects in scalable distributed systems. As will become apparent to those skilled in the art, three guiding principles of our framework are:
1) During testing, we forcibly perturb the environment of the system-under-test (SUT);
2) We leverage awareness of system-internal states to control the application of perturbations; and
3) We support a test policy language framework that automatically generates system-level test code from high-level test policies that specify perturbations to be tested.

With respect to 1) above, and as used herein, by “perturb” we mean inducing a controlled change, and by “environment” we mean those external factors over which an SUT has no direct control. Examples of such environment factors include not only hardware and network failures (e.g. node/link/disk failures, network partitions), but also slow operation (overloaded nodes, congested links), different event orders (e.g. between messages, or read/write events), etc. In other words, our perturbation approach is more general than fault injection and can model any stress from the environment. Our testing platform controls which perturbations to apply, and the precise timing of when to apply them. A major advantage of directly controlling the environment of the SUT is that we do not require setting up a large-scale system to induce stress. Our methodology works on small-scale tests, where environment perturbations directly control the stress introduced on the server side, without requiring large client-side workloads. This helps to reduce the cost of testing.

With respect to 2) above, it is noted that subtle and deep-rooted defects often occur under particular conditions of states or event orders. These are difficult to expose using random or black-box testing alone. To improve the effectiveness of testing, we use abstractions of system-internal states to provide fine-grained control over perturbations. For example, we use conditions (predicates) on internal states of a single node, to control when a perturbation is applied or to choose which node to apply it to. Note that we do not advocate requiring knowledge of all internal states, only of some relevant ones. Advantageously, our platform provides a flexible instrumentation framework that supports selectively defining and using such states during testing. As we will show in our experimental results, this makes our approach more effective than black-box testing in finding defects.

Finally, with respect to 3) above, on one hand it exposes labels that a tester can use to specify perturbations (including their fine-grained control) at a high level. On the other hand, it hides all the low-level system code that implements the perturbation machinery. For example, a tester can simply choose a perturbation that “brings down” a node or a link, without worrying about writing the test code that implements this perturbation at the system level. We believe this can significantly boost the productivity of testers, who can focus more on devising high-level test scenarios, rather than being burdened to provide low-level system code. One of our prototype implementation includes many generic perturbations, e.g. for nodes, links, disks, and memories. In addition, our platform can support addition of application-specific perturbations through a flexible instrumentation framework.

Note that since we forcibly change the system environment, this approach is very well-suited for testing robustness, but not for estimating performance. However, it can be used to find performance defects in implementations that are designed for robustness. Also, our framework caters to testers with a range of skills (from no domain knowledge to expert), different phases of projects (from early development to deployed), and can be customized for new applications.

### Empirical Study

At this point we may now disclose implementation details to understand how partition-tolerance is achieved in practice. More particularly, when one or more environment anomalies occur during communication in a distributed system, a receiver node should not block forever for a response. Various mechanisms, such as exceptions and timeouts are used at the code level to detect such anomalies and to possibly take corrective action.

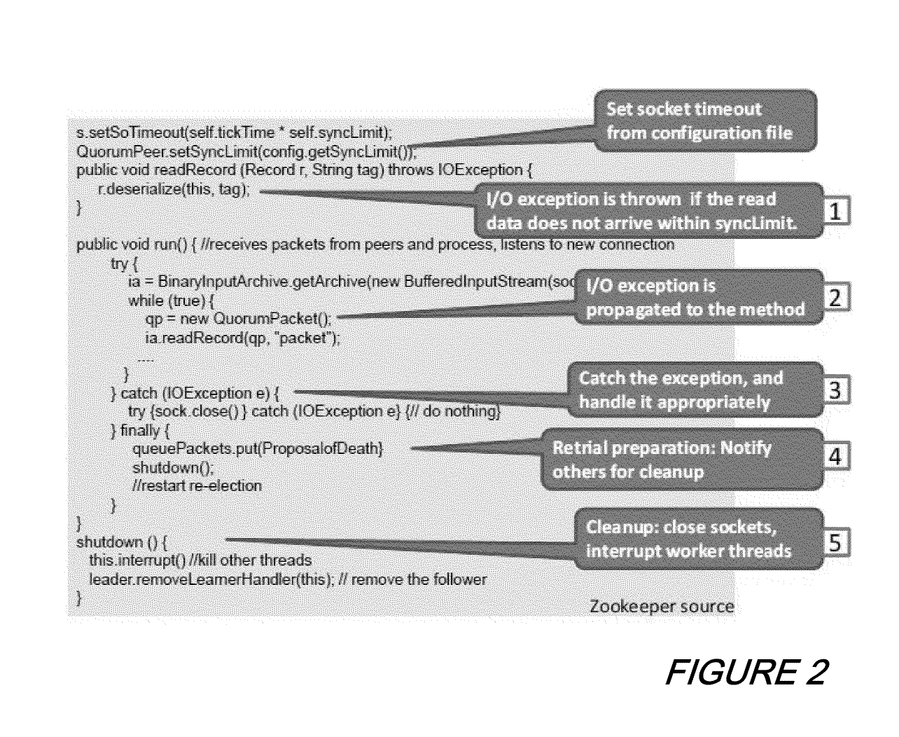

We illustrate these mechanisms with a representative example code snippet from a ZooKeeper application providing consistent and partition-tolerance (CP) service, as shown in FIG. 2. In particular, when a response time exceeds a timeout threshold, the receiver node perceives a loss of message, i.e., it detects a partition. This is shown in the code presented in FIG. 2 as throwing of a timeout exception 1, which is either handled by the same module (that detected a timeout) or propagated to the caller module (e.g., an upper layer in the software stack), 2. Subsequently, partition recovery actions get activated in an exception handler to handle the message loss. The handler actions 3 typically involve re-sending requests to the same or different server nodes for a preset number of times 4, and/or discarding stale data 5. To ensure the recovery goes smoothly is quite challenging, as the recovery process itself may be interrupted by other I/O exceptions. Since ZooKeeper provides a CP service, it has to make sure consistency is not compromised during such complex scenarios.

To provide more useful examples, we have examined publicly available repositories of reported issues in Apache components such as Solr, ZooKeeper, HBASE, HIVE, HDFS, CouchDB, and Cassandra. For our purposes in this disclosure, we will refer to these issues as defects. Notably, they may or may not correspond to bugs in the code.

We have investigated 643 reports related to the implementation of partition-tolerance, such as exception handlers of I/O errors and timeouts. The severity labeled by reporters fell in the following categories: 257 are still open/unresolved (at the time of submission), 34 are blocker, 68 are critical, and 541 are major. Some of these defects are due to implementation oversights such as (a) failure to discard stale data due to expired sessions during cleanup, (b) failure to notify outstanding events in a timely manner, (c) failure to handle unexpected exception during recovery. Some others are performance related defects, such as inappropriate choice of socket timeouts and incorrect parameter settings in configuration files.

On server side, system-level defects typically manifest as node/process crashes, uncaught exceptions, non-termination, file corruption, and inconsistent system states. On the client side, these defects cause response anomalies in terms of latency (i.e., slow response), availability (i.e., no response), and consistency (i.e., incorrect response).

### A Motivating Example

We discuss a motivating example from open source Apache applications called SolrCloud built on ZooKeeper. SolrCloud is a popular distributed file indexing and search system providing CP (consistent, partition-tolerant) web services. A client can index files into the system, search for specific terms in files, and delete files. ZooKeeper is a popular system that provides common services used by many distributed systems like distributed synchronization and configuration management. SolrCloud uses ZooKeeper to maintain configuration information.

To test the robustness of a system to node/network/disk anomalies, a tester may be interested in stressing the system at certain suitable points (internal states) during its execution. In black-box based testing, however, this is not always possible. Indeed, it is quite difficult to control the timing and occurrence of such anomalies. Black-box approaches often rely on large-scale realistic load tests to stress the system, in the hope of triggering such anomalies.

To illustrate these shortcomings more concretely, consider two defects in SolrCloud explained below. Note that the defects occur only when specific anomalies occur at specific points of execution. As may be appreciated, black-box testing does not control timing of anomalies, consequently there is a good chance it might miss the defects.

In SolrCloud (hereinafter “Solr”), a logical index of files is split into a number of partitions called shards. When a client issues a search query for a particular term, Solr servers first find the shard in order to find files for the given search term. Advantageously, this avoids searching the entire logical index. Multiple nodes can serve a shard, but there is a single elected leader per shard that handles all indexing, search, and deletion requests for files in its shard. If the leader is unavailable, then another node (a replica) serving the shard is elected as the leader. Solr uses ZooKeeper to elect and keep track of the shard leaders.

A previously reported defect in Solr reads as follows: “When a leader core is unloaded using the core admin api, the followers in the shard go into recovery but do not come out. Leader election doesn't take place and the shard goes down. This effects the ability to move a micro-shard from one Solr instance to another Solr instance. The problem does not occur 100% of the time but a large % of the time.”

Two scenarios that lead to the observed symptoms were explained by developers as follows: In the first scenario, after the leader of an empty shard becomes unavailable, the other replicas of the shard go into a recovery loop and cannot elect another leader amongst them due to some implementation oversights. Thus, Solr cannot serve any client requests for files in that shard anymore (we call it a response anomaly), even when there are alive replicas serving the shard that are connected to the other nodes.

We capture the above scenario in a testing policy as follows: “When index is empty, bring the shard leader down, and after some time, check for response anomaly.”

In the second scenario, after the leader of the non-empty shard becomes unavailable, the other replicas wait for an excessively long time before they re-start the leader election. The long wait is unnecessary as the replicas have already detected that the leader is down, and should not wait for a long time expecting it to come back up. During the period in which the replicas are waiting, no client requests for the files in that shard can be served. This is clearly a performance issue, affecting the availability or response time of a service.

We capture the above scenario similarly as follows: “When index is non-empty, bring the shard leader down, and after some time, check for response anomaly.”

Note that to expose the defects, one needs to trigger anomalies (leader nodes going down) at specific execution states (when shard is empty or non-empty). We have designed SETSUD Ō such that testers can easily refer to such internal execution states in test policies.

Note that each of the above test scenarios described by the developers requires some close interaction between external triggers and internal states of the system. This is what we mainly target in our testing framework where we aim to: (a) provide an easy and concise way to specify complex test scenarios, (b) abstract and expose relevant system stress points through instrumentation, (c) identify and expose relevant system internals and system-specific abstractions (such as“leader”, “empty shard”) at higher level, and (d) orchestrate the relative timing between perturbations in a sequence.

### Our Contributions

Several controbutions of our disclosure may be summarized as follows:
We focus on improving the robustness of scalable distributed systems by employing a novel perturbation-based testing technique, to expose system-level defects which are otherwise hard to uncover using existing black-box stress testing and failure recovery testing.
We present the design and implementation of a testing framework SETSUD Ō that automates the generation and exploration of various sequences of perturbations, and reports any system-level defect observed. At the core, we have built an instrumentation layer that provides the necessary abstraction to exercise a sequence of perturbations, each perturbation possible predicated on some internal system states.
We also provide a flexible test policy framework which testers can use to specify various perturbation scenarios at a high level, without the burden of supplying low-level system test code. It supports automatic generation of test code from the test policies, and is targeted for both novice and advanced testers.
We describe an evaluation of our testing framework on several open source projects, where we successfully detected several known and some previously unreported defects. Our framework leverages small-scale tests, and avoids upfront infrastructure costs typically needed by large-scale stress testing.

### Overview of SETSUD Ō

### Terminology

As may be readily appreciated, we are interested in testing distributed systems that provide one or more web services in a scalable manner. As described, we use the following terminology.

Perturbation: The act of inducing controlled changes to the execution of an SUT, e.g. a forced invocation of an I/O exception handler.

Perturbation delay: Time taken by the server application to respond to a perturbation.

Perturbation Sequence: A sequence of perturbations, where the next perturbation occurs after the previous one, potentially after the perturbation delay of the previous one.

SUT internal state: A state of an SUT that may not be observable from the outside, e.g., a state where a leader is not yet elected is an internal state of the ZooKeeper.

Defect: A design or implementation oversight that prevents a server application from satisfying system-level requirements. We also refer to it as a system-level defect.

Defect Symptom: Defects can manifest in several forms such as crashes, uncaught exceptions, non-termination, file corruption, inconsistent system states. A defect symptom is a manifestation of one or more defects. We will focus on symptoms from the client viewpoint, (i.e., response anomalies): (a) a slow response (e.g. due to node/network overload), (b) no response (e.g. due to a complete system crash), or (c) an incorrect/unexpected response (due to unexpected or inconsistent data).

### Perturbation Testing: Design Aspects

We now identify four design aspects of our framework based on perturbation testing, according to the present disclosure.

(1) What perturbation scenarios to cover? How to specify them?

The choices in perturbing the execution of SUT are plenty, and one cannot possibly cover them all. We consider perturbing the relative ordering of method calls/handlers that get invoked in response to external triggers such as message notification, I/O exceptions, timeouts, node failures, etc. Notably, we provide mechanisms to explore orderings that are not typically executed during normal loads tests. For example, a socket I/O exception occurring at a node that is waiting for a quorum during leader election is an unusual scenario. We provide a flexible testing policy framework, where a tester can easily specify such testing scenarios at the high level.

(2) What is the mechanism of exercising a perturbation? How and where to perturb the SUT?

Our framework simulates the effect of environment anomalies, without actually creating the anomalies. For example, when a link is “brought down”, we will simulate it by throwing an I/O exception at the nodes on that link, indicating an inability to communicate on that link. Note that simulating the link going down is typically more efficient than bringing it down physically. We provide an instrumentation layer that provides the necessary abstractions to access relevant points of executions of an SUT, such as at method calls and exception/interrupt handlers. These handlers typically get invoked by external triggers such as socket timeouts, node/disk/link failures, and message notifiers. We perturb the SUT by directly invoking these handlers, rather than letting them get invoked by external triggers. Such a mechanism ensures that the SUT gets perturbed by the intended trigger. Furthermore, as a design principle, our instrumentation layer hides this perturbation machinery from a tester. This allows the tester to focus on devising perturbation scenarios at a high level, without being overwhelmed by system implementation details at the low level. We believe this is important for boosting tester productivity.

(3) When should a perturbation be exercised?

We apply a perturbation when a certain enabling condition holds. For example, we decide to force an I/O exception (e.g., simulating a link down) only when the node is waiting for a quorum. Our instrumentation layer also provides such enabling conditions based on abstractions of internal states of the SUT that allow a tester to go beyond black-box testing.

(4) How long to wait between successive perturbations?

While scheduling successive perturbations in a given/desired sequence, we need to orchestrate the relative timing between them. When an external trigger is induced at a node, the effect of the trigger may take some time to propagate before being “felt.” Therefore, we allow a waiting time before inducing the next perturbation. We refer to this as the propagation delay of the perturbation. Consider a test sequence where a communication link is first brought down and then brought up after some time. Note that in most SUT implementations, in order to handle a transient connection loss, a finite number of retrials are made before a link is considered broken. To exercise such a test sequence, i.e., (“link down”, “link up”), it is important to wait for the propagation delay of the link failure before the next perturbation is applied.

The orchestration of perturbations is achieved by a SETSUDO-server running on a separate node, communicating with SETSUDO-clients running on each application server node. The communication between SETSUDO server-client allows observation of system internal states, and issuing perturbation commands. The instrumentation code corresponding to SETSUDO-client is weaved-in with the application code during runtime, without modifying the application code.

To summarize, we in this disclosure we create test scenarios for an SUT by perturbing executions at selected points, mimicking the effect of external triggers that are beyond the control of an SUT. These external triggers cover, but are not limited to hardware/node/link failures. Rather, and of particular advantage, our flexible perturbation-based approach can more broadly target robustness to any environment factor.

### SETSUD Ō Framework

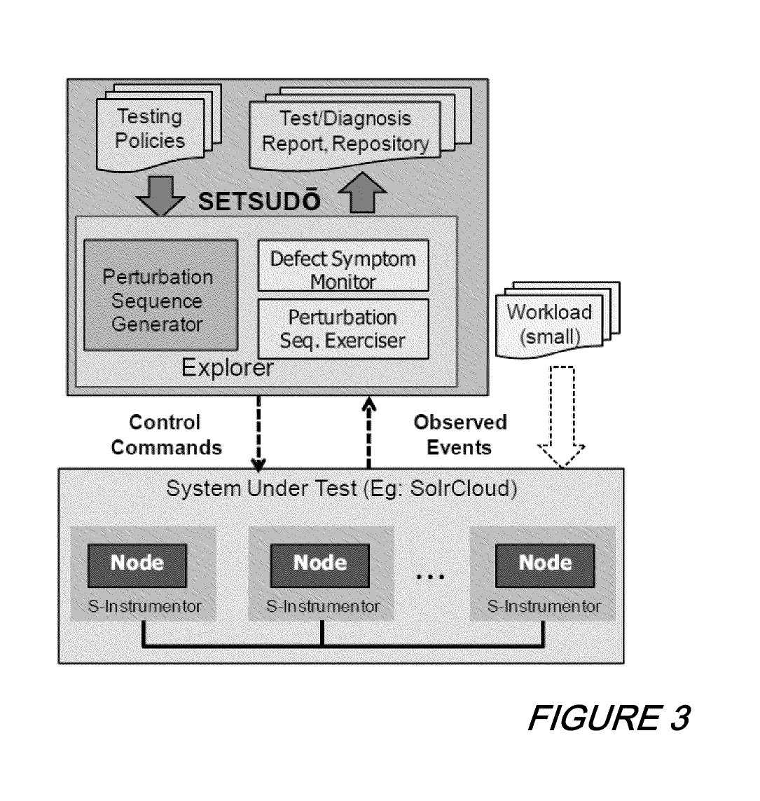

Our testing framework according to the present disclosure is shown schematically in FIG. 3. Operationally, and in a exemplary use case of SETSUD Ō, a tester specifies one or more test policies to capture the perturbation scenarios to cover. (In future work, we plan to automate the specification step as well.) The remaining steps are completely automated, as shown inside the Explorer module. From the specified policies, a set of perturbation sequences is generated. Each perturbation sequence is controlled by a scheduler running on a separate distributed node. Each perturbation is induced using node-level instrumentation (S-instrumentor), e.g. by forcing the invocation of the method call/handler of the corresponding external trigger. The scheduler controls the ordering of, and the timing between, consecutive perturbations. The monitor module checks for any response anomaly during each test sequence. It reports any system-level defects observed, and stores the corresponding test sequence in a repository for later diagnosis. The defects observed are all true defects, as the perturbations applied are environmental triggers. In the following, we briefly describe three components of our framework, namely, (a) Test policy, (b) Perturbation machinery, and (c) Explorer.

Test Policy:

We provide a flexible test policy framework where testers can specify various perturbation scenarios in a declarative style. Specifically, our design of test policy framework is driven by multiple goals—keep it simple for users without domain knowledge, allow flexibility for more advanced users to add more interesting scenarios, and automatically generate test cases from specified policies.

Our instrumentation layer exposes various internals of SUT as a set of labeled entities that a tester can easily understand. These include: (a) dynamic (internal) state of the nodes such as whether a node is a leader or not, (b) abstract (internal) state of SUT, such as whether leader has been elected or not, and (c) perturbation types such as “node down”, “node up”, “read request”, “write request”, “link down”, and so on. A tester can specify a succinct policy using parallel and sequence composition operators to capture a large set of perturbation scenarios. From the specified policies, the Perturbation Sequence Generator module automatically generates sequences of perturbations. At this time, we generate all possible interleavings of the parallel composition operator. In the future, we plan to add reduction techniques or limit the set to non-redundant sequences.

Perturbation Machinery:

For each labeled entity provided to a tester, we have developed the required instrumentation (S-instrumentor) to capture the corresponding semantics. For example, when a “current leader” label is referred, our instrumentation makes it correspond to the node that is the current leader. Similarly, when a perturbation type “link down” is desired, our instrumentation throws I/O exceptions at the nodes connected on the link to capture the effect. Note that we use aspect-based programming to weave in the instrumentation code, without changing the SUT code at all.

Explorer:

To exercise a given perturbation sequence, we have a centralized topology-aware scheduler, Perturbation Sequence Exerciser, that controls the invocation, ordering, and timing of each perturbation in the sequence. The scheduler is a separate node (SETSUD Ō-server) that communicates with the S-instrumentor (SETSUD Ō-client) at each SUT node using messages sent over sockets or remote procedure calls. A perturbation is applied only when the enabling condition holds, as specified in the test policy. Before the next perturbation in the sequence is exercised, the scheduler waits for the propagation delay of the current perturbation. We can also leverage any existing small-scale work loads and perturb executions to cover “hard-to-cover” scenarios. In this paper, our goal is not to advocate any particular coverage-guided exploration strategy. Instead, our focus is on providing enabler utilities that make it easier to experiment with new coverage strategies in the future.

### Testing Policy

We now present our Perturbation Testing Policy Language (PTPL). The goal is to make it easy to understand by both novice and advanced testers, for specifying perturbation scenarios of interest at a reasonably high level. The declarative style of the language allows testers to state their intent, and our automated framework translates this intent into actual perturbation tests at the system level.

We assume that the testers have some basic familiarity with the SUT. The perturbation machinery exposes various internals of the SUT as labeled entities, which the testers can use to write rich and meaningful test policies. Such labeled entities (roughly between 50-100 in our experience so far) are based on information that is readily and publicly available in design documents of open source projects. Many of these labeled entities are generic for service applications, while some are customized for specific applications. In either case, these labeled entities have well-defined semantics, and can be classified into the following types
Targets, T: a set of targets of external triggers. For example, the label node-zkLeader refers to the current zookeeper leader as the target of an external trigger.
Actions, A: a set of actions corresponding to external triggers. For example, the label down refers to the action of bringing a target down.
Prehooks, E: a set of enabling conditions before applying external triggers. Eg., the label dbEmpty corresponds to the condition that the database is empty before applying an external trigger.
Posthooks, P: a set of wait-and-hold conditions after applying external triggers. Eg., the label timedWait corresponds to wait for some time after applying an external trigger.

The above labeled entities serve as terminals in the context-free grammar of our PTPL, shown below. We use additional terminal symbols as operators, with the following semantics. The two operators, parallel (+) and sequential (*), allow composition of perturbation sequences. Boolean connectives (and, or) denote Boolean combinations of prehooks and posthooks. In the grammar shown below, t, a, e, and p denote an element from the sets T, A, E, and P, respectively. (Other terminal symbols such as (,) are used for disambiguation.)
<seq>::=(<seq>+<seq>)|(<seq>*<seq>)|<pt>
<pt>::=(<pre>, t, a, <post>)
<pre>::=(<pre> and <pre>)|(<pre> or <pre>)|e|true|false
<pst>::=(<pst> and <pst>)|(<pst> or <pst>)|p|true|false

A perturbation is defined as a tuple (pre, t, a, pst).

Motivating Examples Revisited:

For the SolrCloud [33] application (described in Section 1.3), we provide various labeled entities to a tester as shown in Table 3. (These labeled entities are shown for illustration, more are available in our implementation.) We also indicate (in Column 3) whether the labeled entity is intended for use in general, i.e., “generic”, or for some specific application, i.e., “zk’ (for ZooKeeper), and “solr” (for SolrCloud).

Given such a list of labeled entities, a tester can write a test policy such as S shown below:
S=(x₀*(x₁*((x₂+(x₃+x₀))*x₀)))

where,
x₀=(state-solrSteady and state-zkSteady, node-client, check-health, abort error)
x₁=(state-healthy, node client, request-indexEmpty, state-indexEmpty)
x₂=(x₂₁*x₂₂)
x₂₁ (true, node-shardLeader-1, down, wait-timed)
x₂₂ (true, node-shardLeader-1, up, wait-timed)
x₃=(x₃₁*x₃₂)
x₃₁=(true, node-shardNonLeader-all, down, wait-timed)
x₃₂=(true, node-shardNonLeader-all, up, wait-timed)

Note that a test policy succinctly captures many perturbation sequences, through use of the composition operators. Specifically, for the policy S, our automated framework generates 5!/(2!2!)=30 possible perturbation sequences from the parallel composition of sequences x₂, x₃, and x₀.

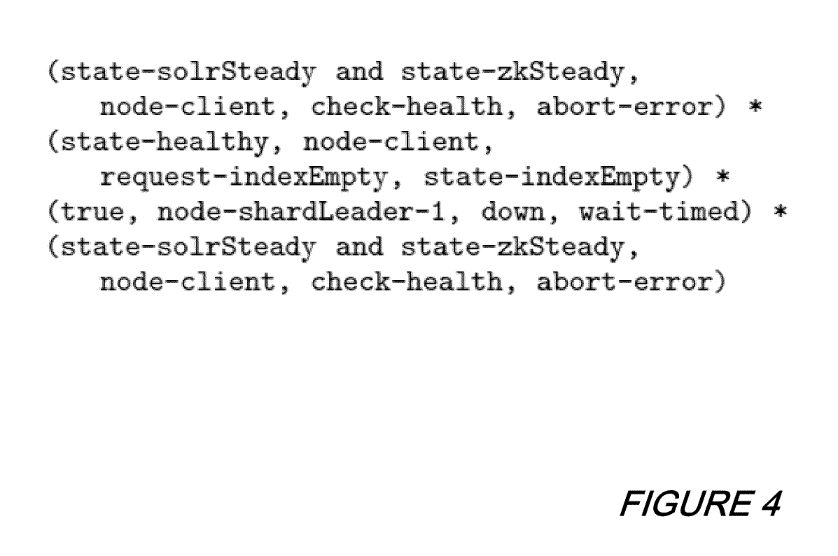

More interestingly, one of these sequences can expose the reported defect SOLR-3939. The specific sequence is x₀*x₁*x₂₁*x₀ (also shown in FIG. 4) is
(state-solrSteady and state-zkSteady, node-client, check-health, abort-error) *
(state-healthy, node-client, request-indexEmpty, state-indexEmpty) *
(true, node-shardLeader-1, down, wait-timed) *
(state-solrSteady and state-zkSteady, node-client, check-health, abort-error)

Our test policies can also be used to specify a particular perturbation sequence to replay a failing test scenario. Although our framework does not guarantee replayability (this is part of future work), our best-effort scheduler often suffices to replay a specific saved sequence. For the defect we have described, the replayable perturbation sequence exposing the first scenario of the defect (as explained in the motivation section) is shown in FIG. 4. The second scenario of the defect can be obtained by replacing the action request-indexEmpty with request-indexNonEmpty, and posthook state-indexEmpty with state-indexNonEmpty, respectively, in the second perturbation.

Perturbation sequences can be specified in a succinct fashion, e.g., the policy S above. They can also be individually specified as shown in FIG. 4. Often it is difficult to guess apriori which specific sequences would expose defects; hence we aim to generate the latter automatically from the former. Note that this language is at a much higher level than the system-level implementations. Our instrumentation bridges this gap automatically. We believe this reduces the burden on testers by hiding low-level system details, while enabling them to devise rich testing policies.

### SETSUD Ō Implementation

We now describe an exemplary implementation of our SETSUD Ō framework in more detail. In this exemplary SETSUD Ō implementation, it includes three components (FIG. 3): (1) S-Instrumentor, that observes the execution of the SUT and intercepts those execution points where the system interacts with its environment, (2) Explorer, that perturbs the execution according to the test policies provided by the tester, and (3) Test Policy Language (PTPL), that enables testers to express the perturbation sequences for testing. We have already described the PTPL in detail in the previous section. We now describe details of the other components.

### The S-Instrumentor

The S-Instrumentor observes a system execution and intercepts relevant execution points. It serves two roles in our framework: (1) exercise the perturbation machinery at each node, and (2) provide suitable abstractions of system-specific states to the tester, i.e., labeled entities in PTPL.

Related to these roles, the first kind of relevant execution point is that where the system interacts with its environment (e.g., network, disk). Since, in this work, we want to test the robustness of a system to unexpected changes in its environment (e.g., network/disk failures, dropped messages, slow links), we identify and intercept the points at which the system interacts with its environment so that the Explorer can later apply perturbations at (some of) those points according to the test policies of the testers. For example, to inject transient or permanent network failures, we need to intercept the system calls that perform network I/O and fail them appropriately (e.g., by throwing exceptions instead of executing the system calls).

The second kind of execution point that the S-Instrumentor intercepts is that which modifies some system-specific state relevant to testers. A tester having high-level knowledge about a system might want to target some states that a system is in during execution, and might want to apply perturbations only when a specific predicate holds over those states. For example, a tester who has read the documentation for ZooKeeper would know that there is a leader election amongst system nodes when the system first boots up. At the end of the election, a node obtains support from a quorum of nodes, and establishes itself as the leader. The tester with this ZooKeeper-specific knowledge might want to perturb the system, say with I/O exceptions when the system is still in the leader election phase. To enable the tester to express this intent in a test policy, the S-Instrumentor intercepts the system execution points where a node establishes itself as the leader or relinquishes its leadership. In general, for a given system, the S-Instrumentor tracks those system-specific changes during execution that a tester might find useful when specifying policies.

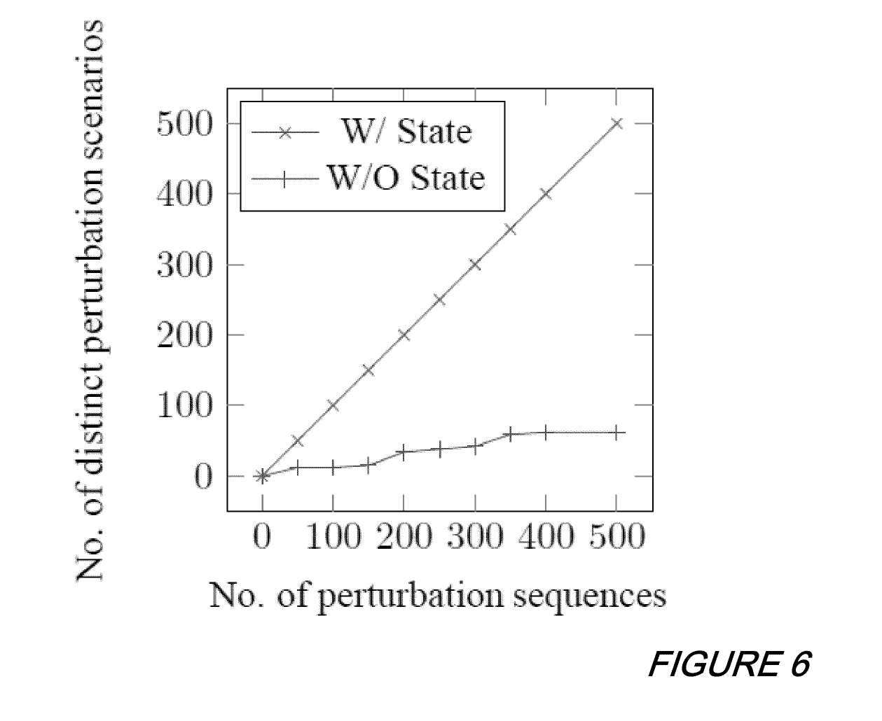

The S-Instrumentor uses AspectJ to intercept execution points of interest. For example, and as shown in FIG. 6, to intercept the point when a node becomes the leader or relinquishes its leadership in ZooKeeper, the Instrumentor uses the following aspects. When a ZooKeeper node becomes the leader, it starts executing the lead( )method in Leader.java. It exits the method when it is no longer the leader. The aspects intercept execution of the lead( )method to determine if a node is the leader or not. For a given system, a tester has to implement aspects for the internal system states that might be needed during testing. In our case, we understood important system states by reading the system documentation (e.g. leaders in ZooKeeper and Solr, and whether index is empty or not in Solr), and could discover defects by using them.

### The Explorer

Given a test policy expressing a set of perturbation sequences, the Perturbation Sequence Generator in the Explorer (FIG. 3) extracts out all perturbation sequences.

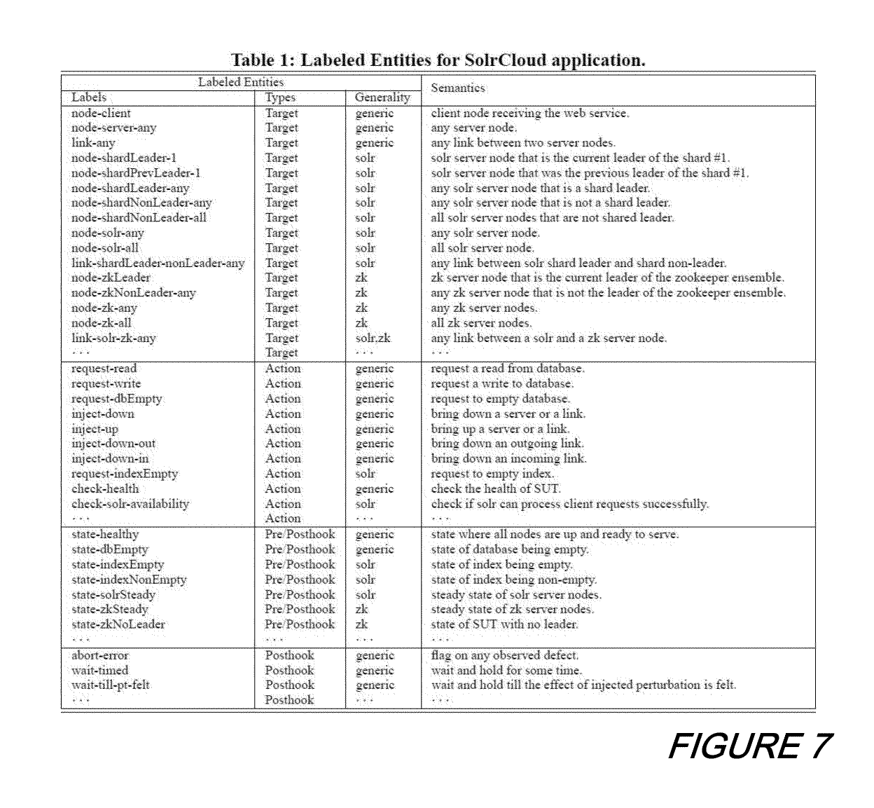

Algorithm 1 (shown in FIG. 7) outlines how the Perturbation Sequence Exerciser (or Exerciser, in short) works on these sequences. For a given set of sequences PS, it applies the perturbations according to each sequence ps based on some given prioritization. For a perturbation pt in a given sequence ps the Exerciser first waits until the condition associated with pt(prehook(pt)) holds. The condition can be a predicate over system-specific state that the tester wants should hold in a state before the perturbation is applied.

For example, a tester may want to simulate a network failure before a leader has been elected in ZooKeeper (to test the resilience of the leader election implementation), or she might want to simulate a node crash after files have been written to Solr (to test if Solr can correctly serve search requests using the remaining nodes). If the tester does not have a specific condition under which to apply a perturbation, or if she does not have any knowledge about the system, then she can skip specifying the condition. In this case, the Exerciser would consider the condition to be true by default. But, advanced testers can take advantage of the condition to have better control over the timing of applying a perturbation. In case a condition is specified, but it never holds during execution, the Exerciser rejects the sequence and moves on to the next sequence in the given set.

After the condition specified in pre-hook (pt) holds, the Exerciser applies the kind of perturbation (e.g., node crash, network failure, or disk failure) specified in pt on the system entities (e.g., node, or network link) specified. For e.g., a tester might specify to crash a node, or to fail a network connection between two nodes. Moreover, if the tester has some system-specific knowledge, then she can be more specific about the system entities on which to apply the perturbation, to have more control over where the perturbation is applied. For e.g., the tester can specify that she wants to crash the node that is the elected leader in ZooKeeper, or that she wants to break off all network communication between a shard leader in Solr and the rest of the nodes. The system-specific execution points intercepted by the S-Instrumentor enable the Exerciser to identify the system entities that match the labeled entities specified by the tester. In the example above, keeping track of when a node establishes itself as the leader in ZooKeeper and when it relinquishes its leadership enables the Exerciser to identify the nodes that are leaders at any point during execution. The tracking of changes in node leadership by the S-Instrumentor allows the Exerciser to apply perturbations in leaders or non-leaders as the tester wants.

After applying a perturbation, a tester might want to wait for the perturbation delay, i.e., until the perturbation is “felt” by the system before moving on to apply the next perturbation. For e.g., after crashing (or isolating) a node, the tester might want to wait until the other nodes try to communicate with the dead (or isolated) node and in the process detect that it is dead (or isolated). Similarly, after a disk failure, a tester might want to wait until the node tries to read from or write to the failed disk and discovers that the disk is out of order. The tester might also want to perform correctness checks before moving on to the next perturbation. Another example in Cassandra, which is a distributed database, is to detect and update stale replicas of rows when an isolated node re-joins other nodes. The tester can specify to wait for the effect of a perturbation to be felt, or perform correctness checks in the post-hook (Algorithm 4.2) of the perturbation. The Exerciser executes the post-hook after applying the perturbation

After applying a perturbation sequence, the Defect Symptom Monitor (FIG. 3) in the Explorer checks the system execution to see if the system behaved correctly after the previously applied perturbations. For Solr, we can check that for each shard that has at least one alive node, a client can successfully connect to that shard and query the files in it. For Cassandra, we can check that reads and writes succeed if there are enough alive nodes to support the specified data consistency and replication levels. The monitors that implement such checks are also abstracted (and hidden) by the S-instrumentor, which provides them as labeled entities in the PTPL so that a tester can decide and specify which of those checks to perform. For example, check-solr-availability in Table 3 ( ) provides the check to determine if Solr is available to its clients. Advantageously, we can add similar labeled entities as checks for other systems.

### Types of Perturbations Implemented

The Exerciser can apply different kinds of perturbations like network failures, network congestions, disk failures, data corruption, node crashes, etc. To fail a network connection between two nodes, instead of allowing the system calls that perform network I/O between the two nodes to execute and return values successfully, the Exerciser forces them to throw I/O exceptions and return unsuccessfully. Recall that the S-Instrumentor already intercepts system calls that perform network I/O. Among the intercepted network I/O system calls, the Exerciser determines the ones performing network I/O between the two nodes under consideration, and forces them to return with I/O exceptions. Thus, a tester can direct the Exerciser to partition a network by failing a network connection between two nodes, or all network connections between two nodes, or completely isolating a node or a set of nodes from all the other nodes.

The Exerciser can also simulate disk failures and data corruption. To fail the disk for a node, as in the case for failing network connections, the Exerciser does not allow the system calls performing I/O with the given disk to proceed successfully. Instead, it forces them to throw I/O exceptions and return unsuccessfully. The S-Instrumentor already tracks and intercepts system calls performing disk I/O. The Exerciser identifies the system calls for the given disk, and fails them. It can also simulate corruption of data read from a disk. For the read system calls that return values read from the given disk, the Exerciser forces them to return randomly-generated values instead of the actual values read from the disk. Other kinds of perturbations that can be applied are node crash or CPU overloads, which are simulated by the Exerciser by killing or temporarily suspending the node process, respectively.

The Exerciser can also exercise perturbations that are not triggered by hardware failures. For e.g., it can force execution of operations with non-zero timeout values (e.g., waits and socket reads with timeouts) to time out, and re-order incoming messages from different nodes. These perturbations can potentially expose performance issues in a system. For e.g., timing out an operation might trigger other operations (e.g., waits with exponential backoff) that might significantly slow down the system. Thus, perturbations in SETSUD Ō are not limited to failures, and any unexpected deviation in execution due to the environment can be considered.

A tester may also want to undo a previous perturbation, e.g. undoing the failure of a network connection between two nodes. The Exerciser would then stop failing the system calls that perform network I/O for the connection with exceptions, and would allow the calls to execute as they would have without its intervention. Similarly, to undo a disk failure, it stops failing the system calls that perform I/O with that disk. To undo data corruption, the Exerciser lets disk reads return the actual values read from the disk, instead of forcing them to return randomly-generated values. To undo a node crash, it re-starts the process for the node. After a perturbation is applied, the system tries to recover from the perturbation (e.g., leader election is re-started after the leader is crashed in ZooKeeper). But, after the perturbation is removed, the system should detect the absence of the perturbation, and should resume any capabilities that it might have lost in the face of the perturbation. (For e.g., re-starting the dead leader should let the node come back up and follow the current leader in the system, and start serving clients). A tester can check if the system correctly resumes its lost capabilities after the perturbation is removed.

Note that our primary goal is not to define coverage in the usual sense of statement or code coverage. Whatever coverage is desired, it is directed in a controlled manner by specifying test policies, which are then translated automatically into test sequences. The focus in this paper is to describe the framework which supports an interface with any external utility to cover the space of possible/desired perturbations.

### Experimental Evaluation

### Implementation Details

We have implemented SETSUD Ō in a prototype tool for distributed systems written in Java. The S-Instrumentor uses AspectJ to intercept system calls performing network and disk I/O, and execution points that modify system-specific state. The Instrumentor uses RPC to communicate with the Perturbation Sequence Exerciser in the Explorer. The Exerciser, which is implemented in Java, updates its system-specific state bookkeeping based on its communication with the S-Instrumentor, and directs the Instrumentor to inject perturbations during network and disk I/O according to the test policies The Exerciser can also inject other perturbations like crashing nodes and rebooting nodes at appropriate points during execution. The Perturbation Sequence Generator and Defect Symptom Monitor are implemented as Python and bash scripts. The entire implementation of SETSUD Ō is about 5K lines of code. Since SETSUD Ō abstracts out and exposes internal system states, the implementation of SETSUD Ō that deals with system-specific states differs from system to system.

Evaluation on real systems

Our framework facilitates exploration of the perturbation space by providing automated utilities for specifying policies, and scheduling and executing the perturbations. We have evaluated the usefulness of SETSUD Ō with different distributed systems: SolrCloud (abbreviated as Solr), a file indexing and search system, ZooKeeper (ZK), a system that provides distributed configuration management and synchronization, Cassandra (Cass), a distributed database, and HBase, another distributed database that uses Hadoop. We added labels for these systems based on our understanding of the systems from reading their online documentation. (Note: Not much manual effort is needed to get started, for creating labels representing internal states. One can gradually add more labels, as one becomes more familiar with an application. For our experiments (none of us was an expert), we added a few key labels (such as leader/non-leader status of a node). Certainly a tester with better knowledge of these applications can write more labels and potentially find more defects. At the same time, we were surprised how easily we could find defects with fairly low effort and relatively little knowledge of these applications.)

We wrote a few test policies for each of these systems, and evaluated SETSUD Ō with those policies. The test policies specify the perturbation sequences to be injected, e.g., crash and reboot nodes, fail network connections, index files, search for specific terms, write key-value pair to database.

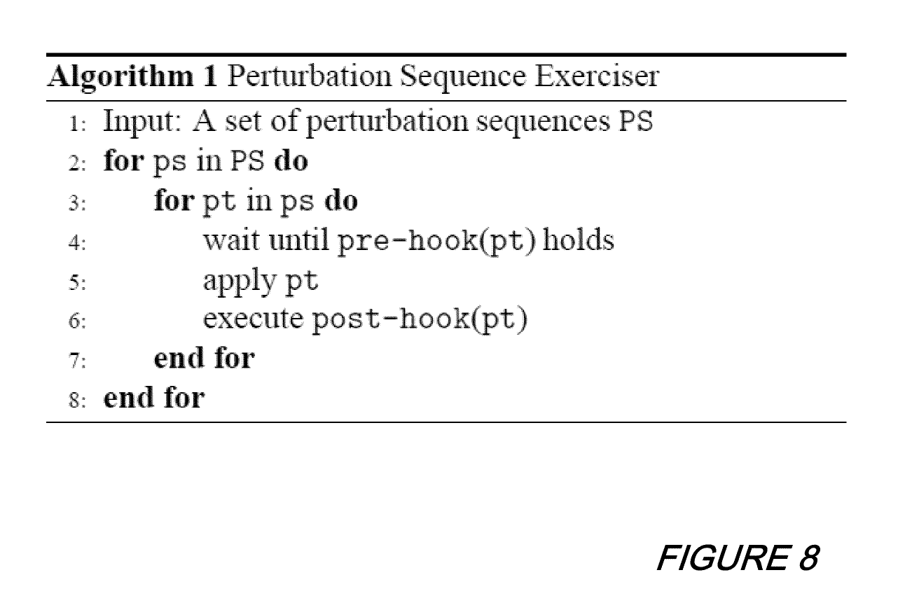

Table 1—shown in FIG. 8 presents the results of evaluating SETSUD Ō for the different systems. The first column in the table is the name of a system, the second column is the test policy for the system, and the third column is the number of perturbation sequences expressed by the test policy. The test policies range from only 6 to 21 lines of code, and the Perturbation Sequence Generator (FIG. 3) takes a few seconds to generate all the sequences from a policy. For each test policy, SETSUD Ō sets up all the servers in the system, and applies all perturbation sequences expressed in the policy one after the other. Before moving on to the next sequence, SETSUD Ō reverses the effect of all perturbations from the previous sequence (e.g., reboot crashed nodes, remove network failures etc.), and brings the servers back to a stable state. Exercising a sequence takes 7 s-138 s for Solr, 7 s-8 s for ZooKeeper, 26 s-32 s for Cassandra, and 1 min-3.5 min for HBase.

The fourth column shown in Table 1 is the number of distinct defects that we found with a policy. Most of the defects that we found involved one or more of the following: (i) multiple perturbations, (ii) specific system entities (e.g., Solr leader and connection between Solr leader and Solr non-leader), and (iii) specific conditions (e.g., empty index in Solr). We could not have found these defects without injecting multiple perturbations or without the system-specific labeled entities in the Test Policy Language. The fifth column in Table 1 indicates if the defect reported was found without using system-specific labeled entities in the policy. As can be seen from the column, this missed most of the defects. This shows the importance of exposing internal system states to testers so that they can use the states in their policies to find corner-case defects. At the same time, if we expose too many internal states, it might overwhelm the testers. Thus, in SETSUD Ō, we identify and abstract relevant internal system states and expose them as simple labeled entities in the PTPL.

The sixth column in Table 1 reports if any defect was exposed by randomized perturbation, where we induced perturbations (such as node crashes and recoveries) randomly, and then checked for any defect symptom. No internal state information was used to decide when and where to apply the perturbations. For each system, we experimented with 500 randomized perturbation sequences. We could find only two defects using random sequences. Finally, the last column in the table reports the number of previously unknown defects that we found, which we explain next.

To some extent, such a framework mimics the known Chaos Monkey Testing. Notwithstanding any such perceived similarities however, in our experiments, we did not find any defect using this framework.

Defects found by SETSUD Ō

As explained previously, Solr splits its logical index of files into a number of partitions called shards, each served by its own leader. We found a previously unreported defect in Solr. It occurs when a shard leader gets disconnected from all other nodes in its shard, but is still connected to the ZooKeeper nodes. Since the non-leader nodes are disconnected from the leader, they cannot serve any client requests, but they did not even re-elect a node amongst them as the leader. As a result, even if there may be a hundred alive nodes in the shard, there is effectively only one node (the leader) that is serving client requests. This can easily over-burden the leader even when the shard has many other nodes that are not getting utilized. To expose this defect, we used Solr-specific state information to identify the leader and the non-leaders in the test policy. We also found previously reported defects (SOLR-3939 and SOLR-3993) in Solr using the policies previously described.

We found defects in ZooKeeper that occur as a result of disk errors and data corruption (explained previously). Also, we created a test policy (T5 in Table 1) that injected random disk and network failures in ZooKeeper. This uncovered a defect in the retry logic of ZooKeeper that caused ZooKeeper servers to die on transient network failures. The problem was caused by the ZooKeeper server not closing a socket explicitly when a network failure occurs. Subsequently, when the ZooKeeper server tries to reestablish the connection, the OS issues an error (“bind: address already in use”) as the corresponding socket was not explicitly closed. The ZooKeeper server gives up after a fixed number of retries. This defect was unknown to us at the time we discovered it (ZooKeeper-3.3.5). It was fixed in a subsequent release (ZooKeeper-3.4.4).

We also found defects in Cassandra that occur due to disk errors. When a Cassandra node starts, it gets assigned a set of tokens that determine its position in the hash ring. We found a previously unknown defect on a Cassandra cluster (with at least two nodes) in which the initial tokens for a node were specified to be computed using the Murmur3Partitioner strategy. When there is at least one node up in the system and another node is trying to compute its tokens and join the system, if there are disk failures in the latter node, that node can crash. We also found previously reported issues in which Cassandra nodes can crash where there are disk errors while flushing in-memory database tables to the disk.

Finally, we also found a previously reported defect (HBASE-6289) in HBase by writing policies that involve bringing down either the outgoing or the incoming links of a node (inject-down-out or inject-down-in Table 2). It is not uncommon for networks to be misconfigured such that the network failure occurs only in one direction. The core HBase system consists of a collection of master nodes, region servers, hadoop HDFS servers, and ZooKeeper servers. One of the region servers is distinguished as a ROOT region server. In the case of HBASE-6289, the defect occurs only when ROOT region server is unable to make outgoing connections, but can accept incoming connections. When the network failure occurs in both directions, the defect does not manifest itself

### Importance of State-Specific Information

We wanted to evaluate several aspects of our framework: (a) exposing internal states, and (b) applying a perturbation only when the state predicates corresponding to the pre-hook are true. Therefore, we performed controlled experiments to compare with: (a) policies where internal state labels are ignored, and (b) policies where perturbations are applied randomly.

Providing state information helps a tester to better express when and where a perturbation should be applied (e.g., apply on the Solr leader when the index is empty). But, a perturbation that does not use state-specific information when executed repeatedly may or may not explore distinct perturbation scenarios. We tried to determine how much state information helps in covering distinct such scenarios.

We generated 500 distinct perturbation sequences for Solr (each with two perturbations) that used state-specific labeled entities (e.g., node-shardLeader-any and node-zkLeader in Table 3). Since each sequence is different from the rest, we cover 500 different perturbation scenarios with these sequences. For each sequence, we also map it to another sequence that does not carry the state information in the former sequence. For e.g., for node-shardLeader-any in the former sequence, we map it to node-solr-any in the latter sequence. Note that the set of 500 latter sequences may not all be distinct. But, even if two of the latter sequences are the same, they can cover two different perturbation scenarios. For e.g., node-solr-any may resolve to a Solr non-leader when exercising one sequence, and to a Solr leader when exercising the other.

The plot in FIG. 6 presents our results on the two sets of sequences, with (W) and without (W/O) the state information, where we counted the number of distinct scenarios covered based on whether the perturbations were applied to Solr leaders or non-leaders in the Exerciser. Note that without the state information, we cover much fewer distinct perturbation scenarios. In this experiment, we had a single Solr shard with four nodes, and three ZooKeeper nodes. In general, as the number of nodes increases, the chances of node-solr-any resolving to the shard leader during execution becomes lower, and similarly, the chances of node-zk-any resolving to the ZooKeeper leader also becomes lower. Thus, exercising corner-case perturbation scenarios (e.g., applying perturbations on internal state entities such as shard leader and the ZooKeeper leader) becomes much harder without state information in real systems.

Our experiments clearly show that perturbation when applied with internal state information are beneficial in practice (not just in principle). A comparative or comprehensive evaluation of different coverage strategies is not the focus of our work; hence we did not present any comparison results, such as with FATE/DESTINI

### Stress Testing

Current stress testing frameworks (such as HP's LoadRunner and QTP, Apache JMeter, Selenium) test system under heavy load conditions to check robustness, availability, tolerance, error handling, etc. The goal is to check if the system has noticeable defects under large and unpredictable network delays and heavy usage. These frameworks have several inherent shortcomings as explained below, and are limited in their ability to expose defects.

Labor-Intensive.

Test scenarios are manually created, and in-depth knowledge of application/system may be needed. Typically, an interactive GUI with templates/forms is provided, which may not capture the range (number, complexity) of test scenarios needed. In contrast, we generate test scenarios automatically from high-level test policies, which are written using labeled entities corresponding to the abstractions of interesting and relevant internal states of SUT (exposed by the instrumentation layer).

Unaware of SUT Internals.

A black-box approach using only client-side workload often fails to explore intricate orderings of events such as I/O exceptions and node failures that are needed for exposing defects that do not occur normally. Although, load and stress testing are aimed to excite such events and orderings, they are often not adequate. In contrast, we perturb a normal execution by various mechanisms, including (but not limited to) invoking certain APIs, exceptions, handlers, configurable parameters, message notifiers in some sequence. The perturbations are directed to find defects not covered under typical load conditions.

High Cost.

Stress/Load testing often requires a large and expensive test infrastructure (machines), and is time consuming due to setting up and exercising individual tests. Instead, our focus is on exposing defects by leveraging small-scale tests with low infrastructure cost. We also avoid redundant tests through reductions during automatic generation of low-level test sequences from high-level test policies.

Limited Coverage.

Testing coverage achieved by stress/load testing is determined by user-supplied test scenarios and input data. We explore complex scenarios targeted to expose defects using available small-scale test data and user-defined declarative test policies.

### Cloud Recovery Testing

There have been recent efforts for cloud testing that focus on testing of recovery functionality when some failures occur. In FATE and DESTINI, failures are systematically injected in disk/node/link in various combinations, followed by checks to see if the system tolerates these failures and behaves as expected, based on user-provided specification. The approach uses a ranking mechanism to exercise various failure scenarios. In PreFail, a tester can specify policies to indicate which failure scenarios to cover and which ones to filter out. The goal is to overcome the explosion in failure scenarios that are tested. To express a failure scenario, a tester has to provide low-level details like the ID of the node in which a failure in the sequence should be injected, or the contents of the execution stack trace when a failure is injected. In contrast, SETSUD Ō provides abstractions of system-specific states (i.e. labels) that can be used by the testers to specify failures (and other more general perturbations), and to decide the granularity at which we want to distinguish between failure scenarios.

### Fault Injection-Based Testing

Random failure injection techniques are quite popular among developers for testing robustness of their system to failures. One particularly useful technique is chaos monkey testing which is routinely employed, where in virtual machines serving web services in the cloud are killed randomly, followed by checks to make sure the system with in-built fault redundancy can still provide adequate service. Random failure injection is easy to implement, but it can miss defects that occur due to intricate orderings of different failures occurring at specific system states. Also, the testers cannot control where/what/when to inject failures.

There has been some prior work to improve over random injection failure techniques. Genesis2 uses fault injection-based testing, targeted for Service-Oriented Architectures (SOA). It allows testers to write scripts to inject failures at various layers, but they have to provide details regarding how to inject the failures. Some efforts focus on testing specific aspects, such as tolerance of applications to errors in returning shared-library calls. LFI provides an XML-based language to write failure scenarios that occur during library calls, but testers have to specify low-level details (such as execution stack trace, call stack depth, type of library calls). In a follow-up work, a fitness metric is used to guide fault exploration. FIG. 3 is another tool that injects failures in library calls in network applications.

A tester can specify the library calls that they want to fail and the frequencies of failures, but the tool does not expose fine-grain control. FAIL-FCI provides a high-level language for testing Grid middleware. Testers have to specify low-level details like function names and keep track of counts and timers to inject failures. Orchestra uses Tcl scripts written by testers to fail or corrupt network messages based on TCP headers of messages. AFEX is another fault injection framework, but for non-distributed software systems. It finds and ranks important faults faster and more accurately than random injection.

Our perturbation-based testing framework is more general than fault-injection based testing, both in terms of broader goals and improved capabilities. It allows more general exploration of state space beyond fault-injections, e.g. changing the order of messages to find concurrency-related defects. We intend to create stressful scenarios for an SUT by perturbing executions at “selected points” such as at specific SUT internal states (e.g. a leader is not yet selected) by using “external triggers” that are not necessarily hardware/node/link failures. Such fine-grained orchestration distinguishes our work from fault injection frameworks. In our approach, external triggers can include any aspects that are not under the direct control of an SUT, e.g. invocation of a socket timeout exception to indicate network congestion. Such triggers can be used to target performance defects also, not just redundancy defects. As such, we do not focus only on testing recovery functionality. Rather, our flexible perturbation-based approach targets testing robustness of a system to any kind of stress from the environment. In terms of capabilities, our SETSUD Ō framework exposes abstractions of internal states of an SUT, which ultimately empowers both the novice and advanced testers to perform finely controlled exploration of system executions.

### Systematic Exploration

There are other fault injection frameworks based on systematic exploration via model checking, such as EXPLODE and FiSC, that explore thousands of program states and inject crashes at every unique program state. MoDist intercepts various OS operations during execution, and exhaustively tests against all possible orderings of those operations and all possible failures that can occur during those operations. DeMeter reduces the number of orderings and failure sequences that a model checker like MoDist has to explore, but the reduction might still not be enough for a tester with constrained resources. In comparison, our framework facilitates exploration of the perturbation space by providing automated utilities for specifying policies, and scheduling and executing the perturbations.

### CONCLUSIONS AND FUTURE WORK

We have presented a testing framework SETSUD Ō that uses perturbation-based exploration for robustness testing of modern scalable distributed systems. Existing testing techniques and tools are limited in that they are typically based on black-box approaches or they focus mostly on failure recovery testing. Our testing approach provides a flexible framework to exercise various perturbations to create stressful scenarios. It is built on an underlying instrumentation infrastructure that provides abstractions of internal states of the system as labeled entities. Both novice and advanced testers can use these labeled entities to specify scenarios of interest at the high level, in the form of a declarative style test policy. Our framework automatically generates perturbation sequences and applies them to system-level implementations, without burdening the tester with low-level details. We have implemented a prototype framework, and our experimental evaluation on various open source applications demonstrates the efficacy of our approach. Especially, we leverage small-scale tests that are often included in open source projects. We do not rely on a large-scale testing infrastructure for stress testing.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method of performing perturbation-based testing of scalable distributed systems under test (SUT) comprising the steps of:
by a computer:
inducing controlled changes to an execution of a SUT using custom triggers that correspond to environment triggers on which the SUT does not have any control; and
monitoring the SUT for any deviation in an expected behavior of the SUT;
reporting any deviations in expected behavior of the SUT.

2. The method of claim 1 wherein said custom trigger(s) comprise a forced invocation of method calls or exception handlers that correspond to external triggers.

3. The method of claim 1 wherein each one of said custom triggers is applied only when one or more condition(s) corresponding to the internal state of the SUT is valid.

4. A computer implemented method of performing perturbation-based testing of scalable distributed systems under test (SUT) comprising the steps of:
by a computer:
specifying testing policies in a declarative style using labeled entities corresponding to internal states of the SUT;
from each specified testing policy, generating one or more combination of perturbation sequences using specified parallel and sequential composition of specified perturbations;
applying the perturbation sequences to the SUT while monitoring for unexpected behavior of the SUT; and
reporting any unexepected behavior of the SUT.

5. A computer implemented method of performing perturbation-based testing of scalable distributed systems under test (SUT) comprising the steps of:
by a computer:
generating a sequence of perturbation sequences to be applied to the SUT wherein each sequence includes one or more triggers;
prioritizing the sequences based on impact scores of each triggered as measured in terms of a perturbation delay, wherein said perturbation delay is a measure of the time required for a handler code of the SUT to complete execution of the handler after observation of the trigger;
applying the sequences to the SUT while monitoring the system for unexpected behavior;
reporting any unexpected behavior.
